(19) United States
(12) Patent Application Publication
(10) Pub. No.: US 2015/0227348 A1
(43) Pub. Date: Aug. 13, 2015

(54) DEVELOPMENT SUPPORT DEVICE AND DEVELOPMENT SUPPORT PROGRAM

(71) Applicant: KABUSHIKI KAISHA YASKAWA DENKI, Kitakyushu-shi (JP)

(72) Inventors: Koji FUCHIKAMI, Kitakyushu-shi (JP); Naoki Mizuno, Kitakyushu-shi (JP); Yusei Ario, Kitakyushu-shi (JP)

(73) Assignee: KABUSHIKI KAISHA YASKAWA DENKI, Kitakyushu-shi (JP)

(21) Appl. No.: 14/695,140

(22) Filed: Apr. 24, 2015

Related U.S. Application Data
(63) Continuation of application No. PCT/JP2012/077704, filed on Oct. 26, 2012.

(51) Int. Cl. G06F 9/44; G06F 9/45

(52) U.S. Cl. CPC G06F 8/311; G06F 8/41

(57) ABSTRACT

A device for supporting development of a control program includes circuitry which accesses a database including control command information which executes operational control or computational processing of a control target, variable name information which is used in the operational control or the computational processing, and variable register information which stores a current value of a variable corresponding to a variable name such that the control command, variable name and variable register information are associated with each other in the database, acquires one or more selected information selected from the control command, variable name and variable register information, analyzes each selected information based on type of the information in the database such that the current value of the variable is acquired according to the variable name information or the register information, and displays the selected information analyzed separately by the type, and the current value of the variable acquired by analysis.

### CROSS-REFERENCE TO RELATED APPLICATIONS

The present application is continuation of and claims the benefit of priority to International Application No. PCT/JP2012/077704, filed Oct. 26, 2012, the entire contents of which are incorporated herein by reference.

### BACKGROUND OF THE INVENTION

1. Field of the Invention

The present invention relates to a development support device and a development support program.

2. Description of Background Art

A development support device is connected to the controller to rewrite a control program in the controller or to debug the control program. For example, a development support device is connected to a PLC as described in JP2008-293138A. In addition, JP2008-293138A and JP H1-244549A describe functions to display variables to monitor them during debugging in the control program. The entire contents of these publications are incorporated herein by reference.

### SUMMARY OF THE INVENTION

According to one aspect of the present invention, a development support device supports development of a control program written in a programming language and stored in a controller for controlling a target. The development support device includes circuitry which accesses a database including control command information which executes operational control or computational processing of the target, variable name information which is used in the operational control or the computational processing, and variable register information which stores a current value of a variable corresponding to a variable name such that the control command, variable name and variable register information are associated with each other in the database, acquires one or more selected information selected from the control command information, the variable name information and the variable register information according to a selection process conducted by a user, analyzes each of the selected information based on a type of the information in the database such that the current value of the variable is acquired according to the variable name information or the register information, displays the selected information analyzed separately by the type of information, and displays the current value of the variable acquired by analysis of each of the selected information. The target is controlled by the controller in which the control program written in the programming language is stored.

According to another aspect of the present invention, a non-transitory computer readable medium has stored thereon a program that when executed by a computer causes the computer having circuitry to execute a development support method for supporting development of a control program written in a programming language and stored in a controller for controlling a target. The development support method includes accessing a database including control command information which executes operational control or computational processing of the target, variable name information which is used in the operational control or the computational processing, and variable register information which stores a current value of a variable corresponding to a variable name such that the control command, variable name and variable register information are associated with each other in the database, acquiring one or more selected information selected from the control command information, the variable name information and the variable register information according to a selection process conducted by a user, analyzing each of the selected information based on a type of the information in the database such that the current value of the variable is acquired according to the variable name information or the register information, displaying the selected information analyzed separately by the type of information, and displaying the current value of the variable acquired by analysis of each of the selected information. The target is controlled by the controller in which the control program written in the programming language is stored.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram schematically showing a state where a computer according to a first embodiment of the present invention is connected to a programmable logic controller (PLC);

FIG. 2 is a view showing a ladder program displayed on the computer screen shown in FIG. 1;

FIG. 3 is a view of a watch window showing a watch list on the screen that displays a ladder program;

FIG. 4 is a view schematically showing the inner structure of the computer shown in FIG. 1;

FIG. 5A is a flowchart illustrating a process for displaying variable values by using a development support program of the first embodiment;

FIG. 5B is a flowchart illustrating a process for displaying variable values by using a development support program of the first embodiment;

FIG. 6 is a view showing a motion program displayed on the screen of a computer according to a second embodiment;

FIG. 7 is a view of a watch window showing a watch list on the screen that displays a motion program;

FIG. 8A is a flowchart illustrating a process for displaying variable values by using a development support program of the second embodiment; and

FIG. 8B is a flowchart illustrating a process for displaying variable values by using a development support program of the second embodiment.

### DETAILED DESCRIPTION OF THE EMBODIMENTS

The embodiments will now be described with reference to the accompanying drawings, wherein like reference numerals designate corresponding or identical elements throughout the various drawings.

### First Embodiment

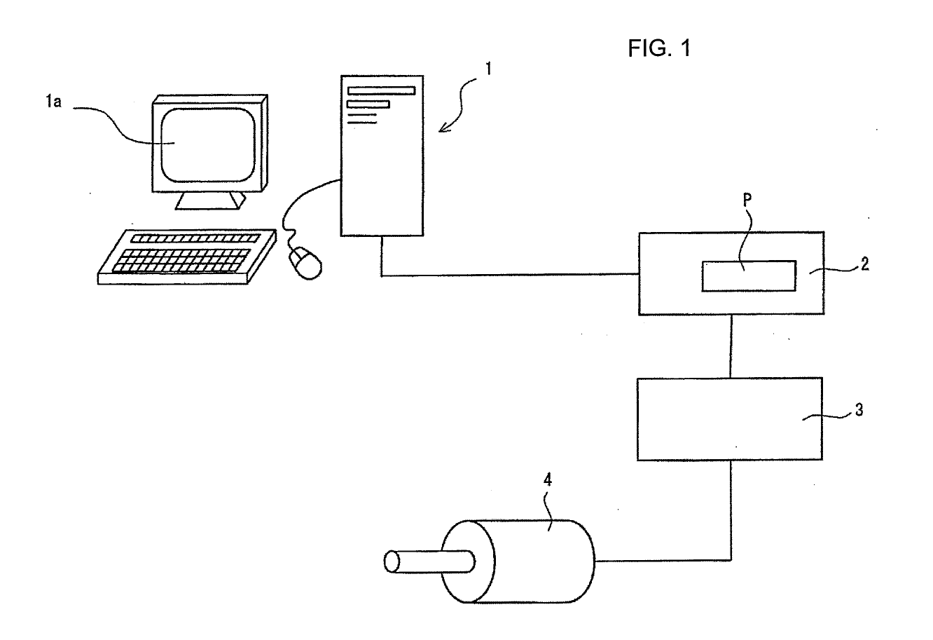

In the following, a first embodiment of the present invention is described by referring to the accompanying drawings. FIG. 1 is a diagram schematically showing a state in which computer 1 as a development support device of the first embodiment is connected to programmable logic controller (PLC) 2. In FIG. 1, reference numeral 3 indicates a servo controller, and reference numeral 4 indicates a servomotor.

PLC 2 stores control program (P). Based on control program (P), PLC 2 sends control commands to servo controller 3. According to the received control commands, servo controller 3 executes operational controls and drive controls on servomotor 4 (control target).

Control program (P) is constructed with a ladder program written in ladder logic or with a motion program written in motion language. It is also an option for control program (P) to be written in both ladder logic and motion language. For example, a main program may be written in ladder logic, while a subprogram in the main program is written in motion language.

Here, a ladder program is a control program written in ladder logic. Logic gates such as a switch, timer and lamp along with variables are arrayed on the inner side of power lines or on rungs, and are executed (scanned) by a ladder program. A motion program is a control program constructed with single or multiple lines written in motion language. Each line can include multiple commands, variables and computational formulas, and the program is executed line by line. The first embodiment is an example of control program (P) written in ladder logic.

Control program (P) is created and compiled using computer 1 and then stored in PLC 2. To compile a control program (P) already stored in PLC 2, computer 1 and PLC 2 are connected and control program (P) is loaded from PLC 2 to computer 1. Then, the program on computer 1 is compiled, and when the compiling process is completed, control program (P) is saved (stored) again in PLC 2.

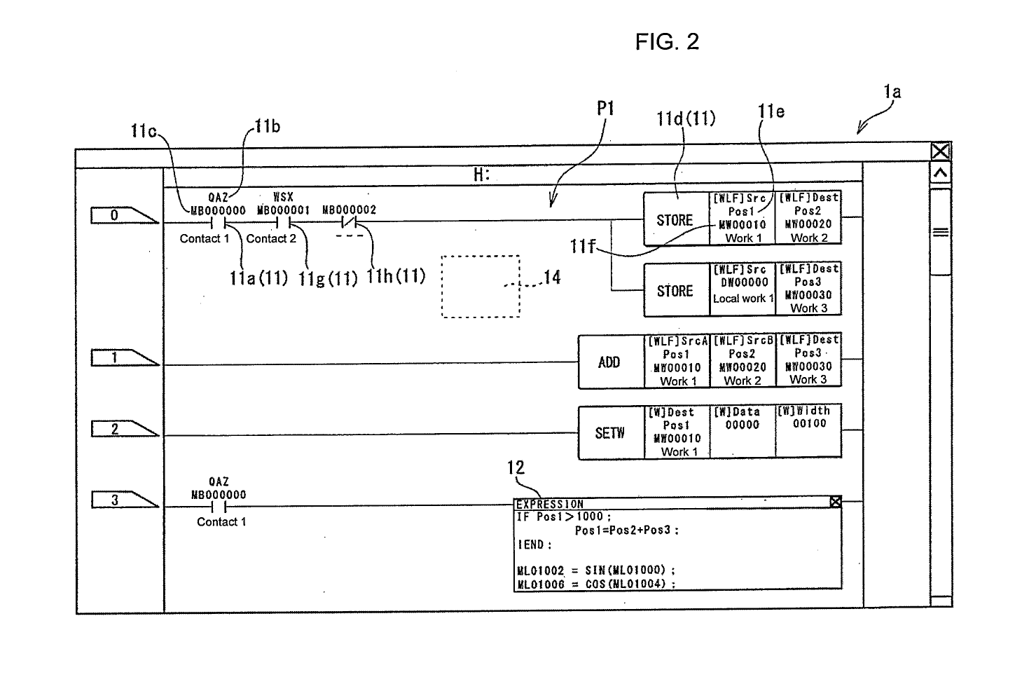

FIG. 2 is a view showing ladder program (P1) displayed on the screen (display screen) (1a) of computer 1. Ladder program (P1) is a control program (P) written in ladder logic. When a control program (P) is created by computer 1, or when the control program (P) is compiled by loading it to computer 1, ladder program (P1) is displayed in screen (1a).

In FIG. 2, reference 11 denotes an element. An element of ladder program (P1) is a command (control command) associated with a variable. Commands include logic gates such as a switch, a timer, a lamp and the like. In addition, commands include computational processing such as ADD (addition) and STORE (storing process). For example, reference (11a) indicates a switch as an element, reference (11b) is a variable in switch (11a), and reference (11c) is a register (register for the variable) in which variable (11b) is stored. Reference (11d) indicates a storing process as an element, reference (11e) is a variable in storing process (11d), and reference (11f) is a register in which variable (11e) is stored.

Screen (1a) also displays expression window 12. Expression window 12 is a window frame as an element displayed on the inner side of power lines or on a rung based on the expression function included in ladder program (P1). Commands, computational processing, variables or the like described in a text format are displayed in expression window 12. By arranging expression window 12 on the inner side of power lines or on a rung, the commands, computational processing or the like written in a text format inside the window can be executed.

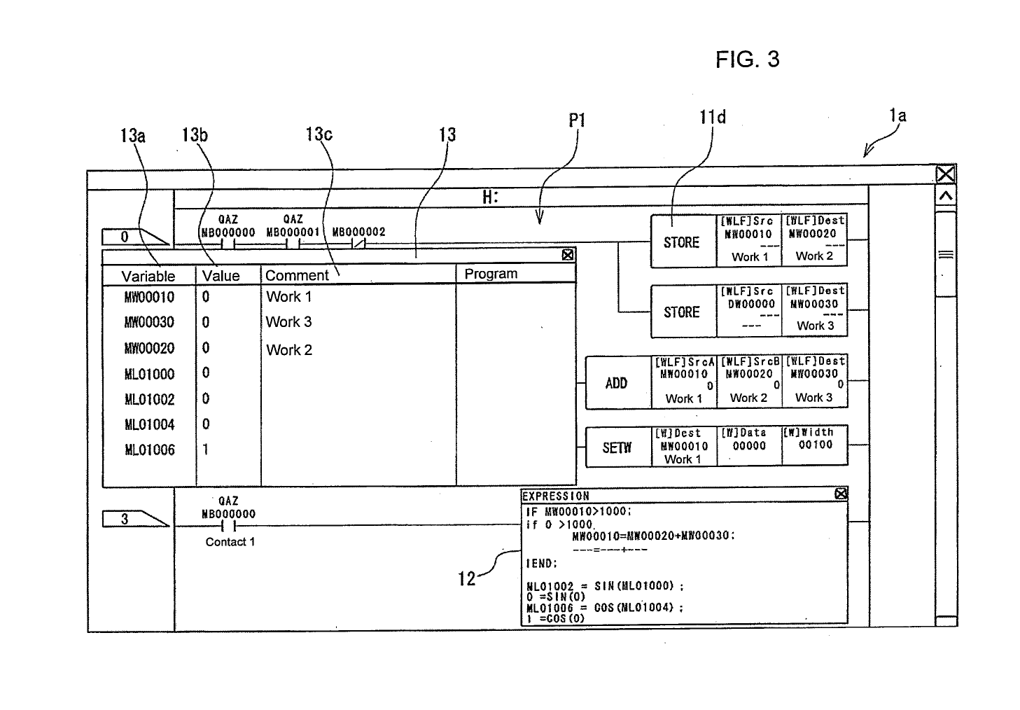

FIG. 3 is a view showing watch window 13 as a watch list displayed on screen (1a) of ladder program (P1). Watch window 13 is displayed according to functions of development support program (Pa).

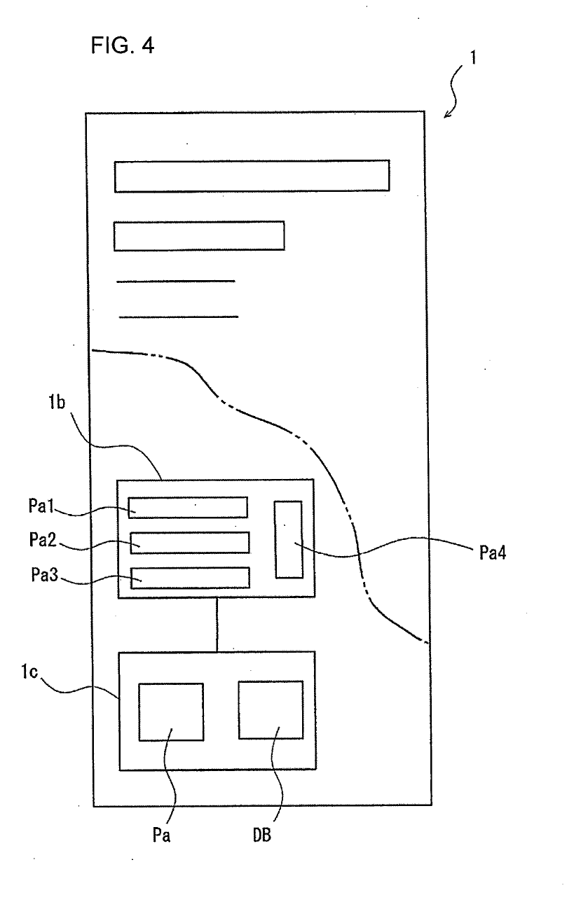

FIG. 4 is a diagram schematically showing the internal structure of computer 1 (development support device). Computer 1 is connected to a display device having screen (1a), and includes CPU (1b) (central processing unit) as a main unit of computer 1 and memory (1c) as a memory device of computer 1. Development support program (Pa) is stored in memory (1c). Development support program (Pa) directs computer 1 to work as a development support device. Detailed descriptions will be provided later. Database (DB) is also stored in memory (1c).

Database (DB) stores commands, variable names and registers for the variables as data to be used in ladder program (P1). Examples of commands are a switch, timer, lamp, SIN function, COS function, STORE (storing process), ADD (addition) and the like. Also, examples of instruction codes corresponding to commands are 0x00 for switch (11a), 0x02 for storing (STORE) (11d) and the like. Variable names are determined by a user and defined in ladder program (P1); for example, variable names such as “QAZ”, “WSX”, “Pos1” and “Pos2” are used in the first embodiment. Registers for the variables are structured, for example, with a type of register (I/O/M/C/D . . . ), a data type (B/W/L/F/Q . . . ) and an address (5-digit numbers), and shown as “MW00010”, “MB00001”, “DW00000” or the like.

Development support program (Pa) directs CPU (1b) to work as display unit (Pa1), selection unit (Pa2) and analysis unit (Pa3) to monitor variables in ladder program (P1).

Display unit (Pa1) has a function of displaying watch window 13 on screen (1a) of computer 1. Display unit (Pa1) is set to display watch window 13 on screen (1a) when development support program (Pa) starts. More specifically, development support program (Pa) may be started by double-clicking its icon. Alternatively, a button for starting development support program (Pa) may be displayed in the compiling screen of ladder program (P1), and development support program (Pa) may be started when the button is clicked.

Display unit (Pa1) has a function of displaying in watch window 13 information such as variable names, registers for the variables and comments that are selected by selection unit (Pa2) and analyzed by analysis unit (Pa3). Also, display unit (Pa1) has a function of displaying in watch window 13 variable values (current values of a variable) acquired by analysis unit (Pa3) based on the information provided under the variable name or register for the variable. As shown in FIG. 4, variable column (13a), variable value column (13b), and comment column (13c) are formed in watch window 13. Based on the analysis conducted in analysis unit (Pa3), display unit (Pa1) displays variable name information in variable column (13a), variable value information in variable value column (13b), and comment information in comment column (13c). Instead of the variable name, or along with the variable name, variable column (13a) may display register information that stores the variable.

When the information selected by selection unit (Pa2) is updated for a short period of time, display unit (Pa1) does not display in watch window 13 such information with a short selected time (the time in which the selected information continues to be selected). Such a function may be executed by selection unit (Pa2) or display unit (Pa1).

Selection unit (Pa2) has a function of acquiring information selected by a user and forwarding the information to analysis unit (Pa3). More specifically, when development support program (Pa) is started, and when a user selects information on the edit screen of ladder program (P1) by using input methods such as a keyboard or a mouse, selection unit (Pa2) acquires the information and forwards it to analysis unit (Pa3). A user selects information, for example, switch (11a), by clicking it with a mouse, for example. Generally, selected switch (11a) will be highlighted.

By moving the selected position using keyboard cursor keys “↑”, “↓”, “←”, or “→”, new information is selected, namely, acquired information will be updated. For example, after the information for switch (11a) is acquired by clicking switch (11a) with a mouse in FIG. 2, when a right cursor key “→” is pressed once, switch (11g) is selected. Accordingly, the information acquired by selection unit (Pa2) is updated from the information for switch (11a) to the information for switch (11g). At that time, the highlighted position on screen (1a) is also moved from switch (11a) to switch (11g).

When the cursor key “→” is pressed again, switch (11h) is selected. The information acquired by selection unit (Pa2) is updated from the information for switch (11g) to the information for switch (11h). At that time, the highlighted position on screen (1a) is also moved from switch (11a) to switch (11g).

By swiftly pressing the cursor key “→” twice, the element selection is promptly moved from switch (11a) to switch (11g) to switch (11h). During that time, if switch (11g) is selected only for a short period of time (200 msec., for example), display unit (Pa1) will not display in watch window 13 the information for switch (11g) (information such as the variable name “WSX”, the value of variable “WSX”, the register that stores the value of the variable, and so on). When element information or text information is selected for a duration (hereinafter referred to as selected time) shorter than a predetermined time, selection unit (Pa2) executes a function not to display the information. Namely, only when the selected time for the information for switch (11g) is a predetermined time (200 msec.) or longer, selection unit (Pa2) forwards the information for switch (11g) to analysis unit (Pa3), whereas when the selected time for the information for switch (11g) is shorter than a predetermined time (200 msec.), selection unit (Pa2) does not forward the information for switch (11g) to analysis unit (Pa3). In other words, it means that selection unit (Pa2) selects the information when the selected time for the information is a predetermined time or longer, but it does not select the information if the selected time is shorter than the predetermined time.

As described above, when a user does not intend to select the information (when the user is moving the cursor), setting a predetermined selected time for acquiring information allows the display unit to spare unnecessary updates from being displayed (that is, the selection unit does not have to execute the process of acquiring the variable name, register for the variable, comment, and current value of the variable). As a result, delays in other functions are prevented, and a decrease in performance is thereby prevented.

It is an option, for display unit (Pa1) to execute the above function, that is, not to display the information in window 13 when the selected time for acquiring the information is shorter than a predetermined time. For example, even when the information for switch (11g) is forwarded from selection unit (Pa2) to display unit (Pa1) via analysis unit (Pa3), if the time for selecting switch (11g) by selection unit (Pa2) is a short period of time (shorter than a predetermined time), display unit (Pa1) may be structured not to display the information for switch (11g) in watch window 13. No information to be acquired is associated with empty column 14 on screen (1a). Therefore, no information is acquired even if a user clicks empty column 14 using a mouse.

Analysis unit (Pa3) has a function of analyzing the information selected by selection unit (Pa2) (selected information) piece by piece. The information received from selection unit (Pa2) includes single or multiple pieces of information, namely, command information, variable name information, variable register information and/or comment information. Analysis unit (Pa3) receives from selection unit (Pa2) such mixed pieces of information, analyzes them, and forwards the results to display unit (Pa1).

Based on database (DB), analysis unit (Pa3) analyzes the information selected by selection unit (Pa2). Database (DB) stores commands, variable names and registers for variables as data to be used in ladder program (P1). Analysis unit (Pa3) collates the information acquired by selection unit (Pa2) with the data in database (DB), and analyzes the acquired pieces of information as command information, variable name information or register information. When information included in the acquired pieces of information does not collate with any data in database (DB), or when a tag information is attached to indicate it is comment information, the analysis unit analyzes it as comment. The analyzed information is forwarded to display unit (Pa1).

When a user selects expression window 12, the information from selection unit (Pa2) is in a text format. In such a case, analysis unit (Pa3) verifies that the information received from selection unit (Pa2) is text information, analyzes the pieces of text information as command information, variable name information, register information or comment information, and then forwards such information to display unit (Pa1).

When register information for a variable is included in the information acquired by selection unit (Pa2), analysis unit (Pa3) has a function capable of acquiring the value (variable value) stored in the register and forwarding it to display unit (Pa1). When the information acquired by selection unit (Pa2) includes the information for a variable name but not information for the register corresponding to the variable, analysis unit (Pa3) has a function capable of acquiring the register information corresponding to the variable (namely, a register that stores the value of the variable) and the value stored in the register, and then forwarding the acquired information to display unit (Pa1).

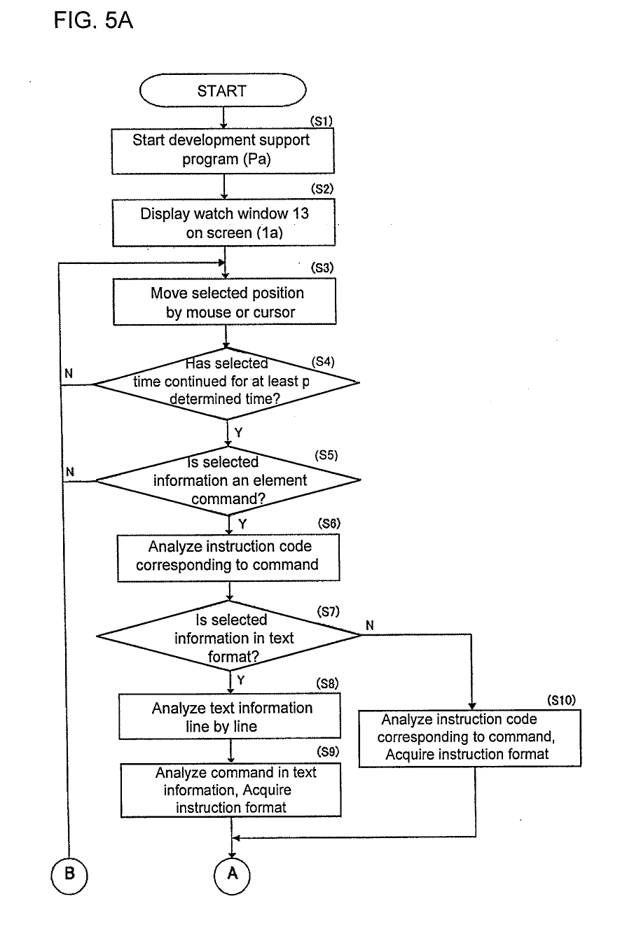

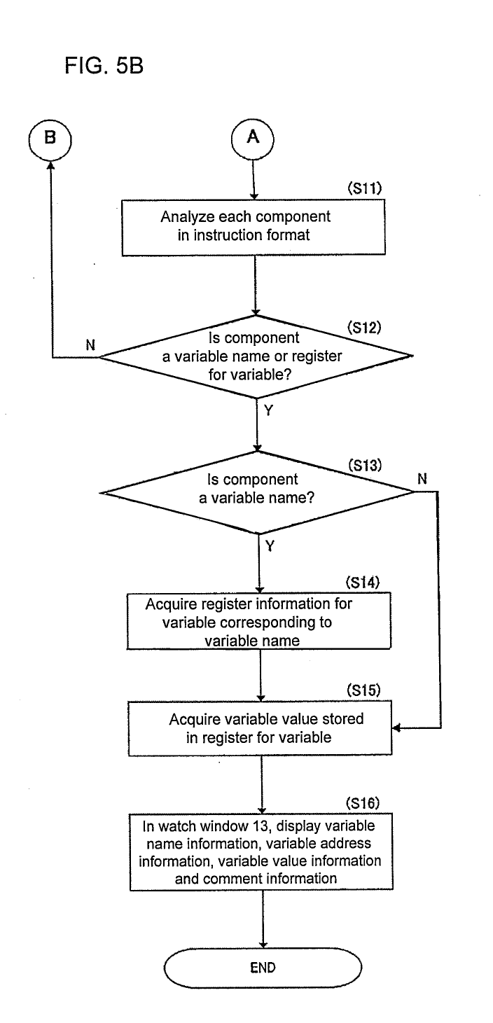

Next, the process for displaying the value of a variable by using development support program (Pa) is described with reference to flowcharts shown in FIGS. 5A and 5B.

Development support program (Pa) is started while ladder program (P1) is compiled (S1). When development support program (Pa) is started, watch window 13 is displayed on screen (1a) by display unit (Pa1) (S2). The selected position on screen (1a) moves when a user operates a mouse or cursor keys of the keyboard (S3). The selected time on the selected position is determined whether it continues for a predetermined duration (for example, 200 msec.) or longer (S4). If the selected time continues for a predetermined duration or longer, the information for the selected position (switch (11a), for example) is selected by selection unit (Pa2), and forwarded to analysis unit (Pa3).

Analysis unit (Pa3) analyzes the information selected by selection unit (Pa2). When the selected information is an element command (S5), analysis unit (Pa3) analyzes the instruction code corresponding to the command (S6). When the selected information is a command in text format (S7), analysis unit (Pa3) analyzes the text information line by line (S8). Then, analysis unit (Pa3) analyzes the command used in the text information and acquires an instruction format (S9).

When analysis unit (Pa3) determines whether or not the selected information is an element command, or the unit analyzes the text information line by line, the analysis unit analyzes such information by collating it with the data in database (DB). Namely, analysis unit (Pa3) collates the selected information with the data stored in database (DB), and determines that the selected information is a command when it is consistent with the command data in database (DB). An instruction format shows a data array corresponding to the instruction (command); namely, it is a list of instructions described using the command, variable name, register or comment to specify a data array for each command.

For example, a computational formula “ML01002=SIN(ML01000)” is described here. When a command is a SIN function, the instruction format specifies that the data following SIN is a variable name or a register for the variable. Also, the data placed before “=” is specified to be a variable name or the register. Based on “M” and “L” in the data, the data before “=” and data following “SIN” in the above computational formula are analyzed to show they are registers for a variable.

When the selected information is not a text format command (S7), the instruction code corresponding to the command is analyzed and the instruction format is acquired (S10). Analysis unit (Pa3) analyzes each component in the acquired instruction format (S11). Namely, each component in the instruction format is analyzed to determine whether it is a command, variable name, register for the variable or comment.

Analysis unit (Pa3) determines whether or not the component in the instruction format is a variable name or a register for the variable (S12). When, the component is a register for the variable (S13), the value of the variable stored in the register is acquired (S15). When the component is a variable name (S13), the information for the register corresponding to the variable name is acquired (S14), and the value of the variable stored in the register is obtained (S15).

Analysis unit (Pa3) may also determine whether a component in an instruction format is a comment or a register for the comment, in the same manner as it determines whether it is a variable name or a register for the variable. When the component is determined to be a register for the comment, the comment stored in the register is acquired. When the component is a comment, the information for a register corresponding to the comment is acquired, and the comment stored in the register is obtained. Whether a component is a comment or not may also be determined by the presence of a comment tag. Alternatively, analysis unit (Pa3) may determine it is a comment if it is found not to match any data in the database when collated with database (DB).

Pieces of information about the command, variable name, register for the variable, and value of the variable as the analysis results are forwarded by analysis unit (Pa3) to display unit (Pa1). Display unit (Pa1) displays in watch window 13 the variable name information, variable register information, variable value information and comment information received from analysis unit (Pa3) (S16). At that time, display unit (Pa1) displays the variable name information or the variable register information in variable column (13a), the variable value information in variable value column (13b), and comment information in comment column (13c).

### Second Embodiment

The following are descriptions for development support program (Pa) according to a second embodiment and computer 1 as a development support device that stores the program. Structures the same as or identical to those in the first embodiment are assigned the same references and their descriptions are omitted in the second embodiment.

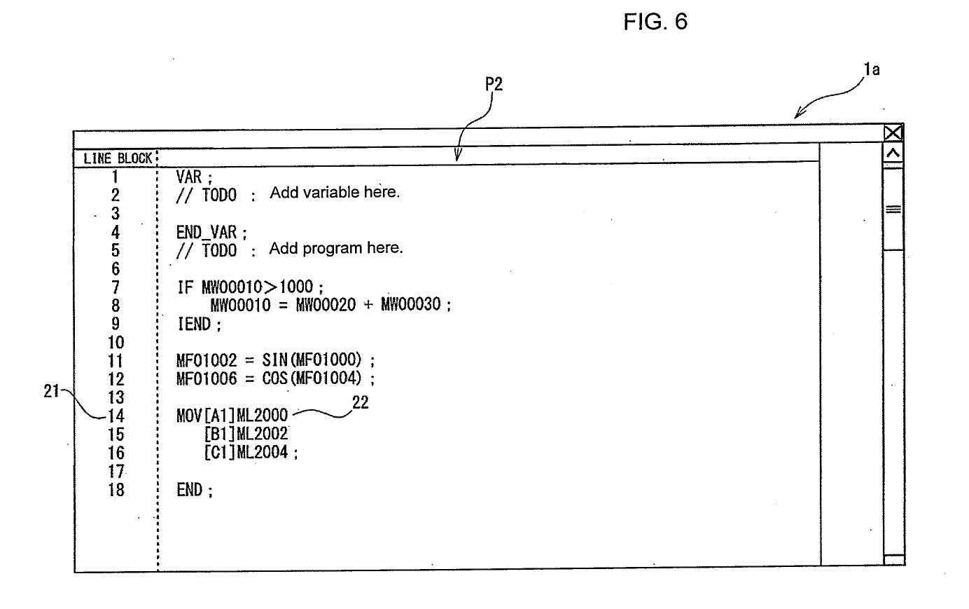

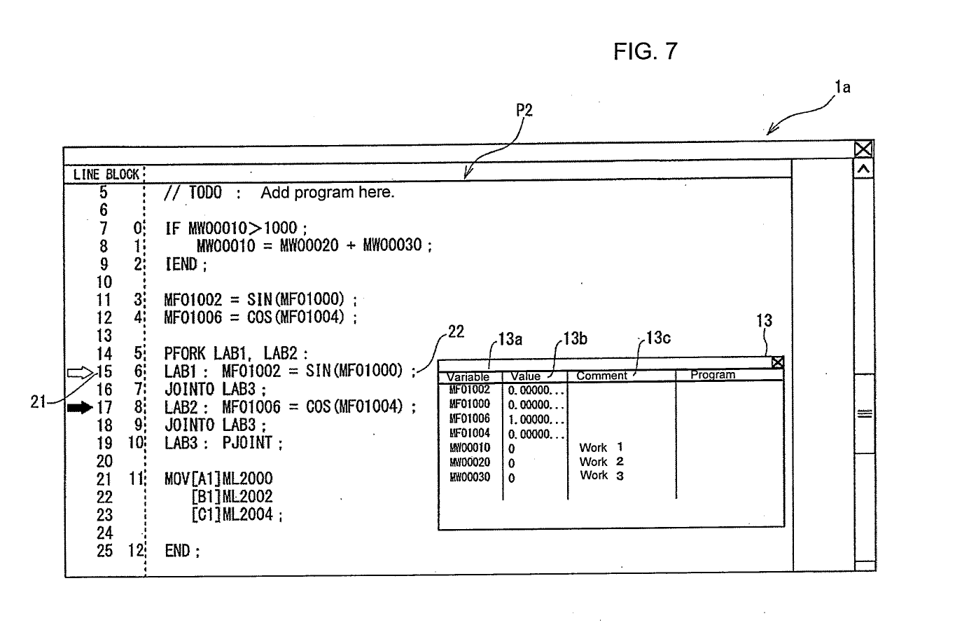

In the second embodiment, control program (P) is constructed with motion program (P2) written in motion language. Control program (P) is created by computer 1 and stored in PLC 2 after being compiled. FIG. 6 is a view showing screen (1a) of computer 1 that displays motion program (P2). When control program (P) is created by computer 1, or when control program (P) is loaded and compiled in computer 1, motion program (P2) is displayed on screen (1a). FIG. 7 is a view showing watch window 13 as a watch list displayed on screen (1a) of motion program (P2). Watch window 13 is displayed according to a function of development support program (Pa).

In FIG. 6, reference 21 denotes a line number, and reference 22 denotes a source code of motion program (P2). Source code 22 is a text written line by line. At least one of a command (control command), name of a variable and register for the variable is included as text information in source code 22. Development support program (Pa) according to the second embodiment directs CPU (1b) described above with reference to FIG. 4 to function as display unit (Pa1), selection unit (Pa2) and analysis unit (Pa3), and monitors variables in motion program (P2).

In the second embodiment, selection unit (Pa2) selects source code 22 line by line. Namely, when a user selects one line number 21 using a mouse or a cursor key, selection unit (Pa2) selects the text information in source code 22 that corresponds to the selected line number 21. When a user selects part of a source code 22 using a mouse or a cursor key, selection unit (Pa2) selects the entire source code 22 in the line number 21 corresponding to the partially selected source code 22.

Development support program (Pa) also directs CPU (1b) to function as a status determination unit (Pa4). Status determination unit (Pa4) is capable of determining whether or not motion program (P2) has been compiled. Moreover, status determination unit (Pa4) is capable of determining whether or not motion program (P2) is executed.

When status determination unit (Pa4) determines that motion program (P2) has not been compiled yet (namely, it is being compiled), analysis unit (Pa3) analyzes line by line the text information for the source code 22 selected by selection unit (Pa2). When status determination unit (Pa4) determines that motion program (P2) has been compiled and is not executed, analysis unit (pa3) analyzes the text information for the source code 22 selected block by block by selection unit (Pa2). At that time, a block may include multiple lines. When status determination unit (Pa4) determines that motion program (P2) has been compiled and is executed, analysis unit (Pa3) analyzes block by block the text information for the source code 22 corresponding to the position of the running motion program (P2) and the text information for the source code 22 selected by selection unit (Pa2). At that time, a block may include multiple lines.

Here, a block means a series of commands written in single or multiple lines, or a set of computational formulas. When a source code 22 is text information, a series of commands or computational formulas is not always written in one line. For example, a computational formula “ML01000=SIN(ML01002)+ML01004” may be split by a line break into “ML01000=SIN(ML01002)” in the first line and “+ML01004” in the second line. When text information is analyzed line by line, only “ML01000” and “ML01002” are analyzed as the registers for variables if the first line is selected in such a case. When text information is analyzed block by block, the text information (series of computational formulas) in two lines is analyzed as registers for variables by selecting any position in the block (namely, any position in the text in the first line or the second line) by using a mouse or moving a cursor. Namely, in the analysis conducted by the block, by selecting any position in the block, “ML01000”, “ML01002” and “ML01004” are all analyzed.

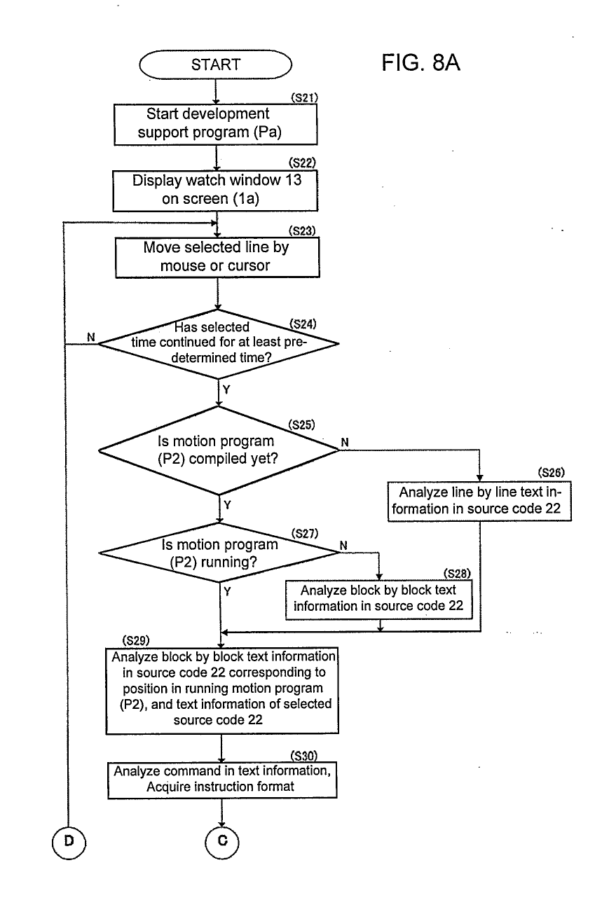

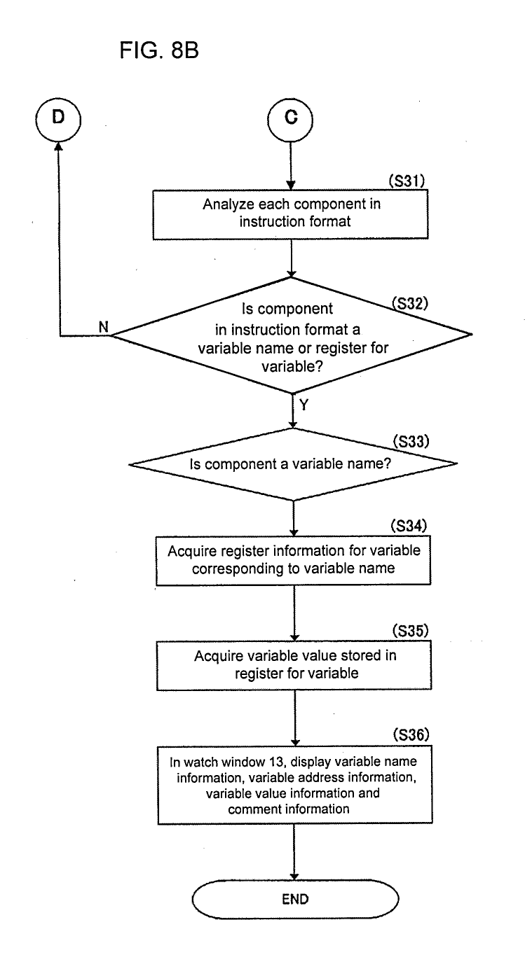

Next, the process for displaying the value of a variable by using development support program (Pa) is described by referring to flowcharts shown in FIGS. 8A and 8B.

When motion program (P2) is being compiled or has been compiled, development support program (Pa) is started (S21). Watch window 13 is displayed by display unit (Pa1) on screen (1a) when development support program (Pa) has started (S22). The selected line on screen (1a) moves when a user operates a mouse or a cursor on the keyboard (S23). The selected time in the selected line is determined whether it is a predetermined time (200 msec., for example) or longer (S24). When it is beyond the predetermined time, information in the source code 22 corresponding to the selected line 21 is selected by selection unit (Pa2). Then, the text information in source code 22 is forwarded to analysis unit (Pa3). Analysis unit (Pa3) analyzes the information selected by selection unit (Pa2).

When status determination unit (Pa4) determines that motion program (P2) is not compiled yet (is being compiled) (S25), analysis unit (Pa3) analyzes the text information in the source code 22 line by line (S26). When status determination unit (Pa4) determines that motion program (P2) has been compiled (S25) and is not executed (S27), analysis unit (Pa3) analyzes the text information in source code 22 block by block (S28). When status determination unit (Pa4) determines that motion program (P2) has been compiled (S25) and is executed (S27), analysis unit (Pa3) analyzes block by block the text information in the source code 22 corresponding to the position in the running motion program (P2) and the text information in the source code 22 selected by selection unit (Pa2) (S29).

The command used in the selected text information is analyzed by analysis unit (Pa3), and an instruction format is acquired accordingly (S30). Analysis unit (Pa3) analyzes each component in the acquired instruction format (S31). Namely, each component in the acquired instruction format is analyzed to determine whether it is a command, variable name, register for the variable or comment.

When analysis unit (Pa3) analyzes text information by the line or by the block, such analysis is conducted by collating it with data in database (DB). Namely, when analysis unit (Pa3) collates the selected information with information in database (DB) and finds that the selected information is consistent with command data in database (DB), the analysis unit determines that the selected information is a command. How to acquire an instruction format has been described in the first embodiment above, and thus its description is omitted here.

Analysis unit (Pa3) determines if a component in the instruction format is a variable name or a register for the variable (S32). When the component is a register for the variable (S33), the value of the variable stored in the register is acquired (S35). When the component is a variable name (S33), the information for a register corresponding to the variable name is acquired (S34), and the value of the variable stored in the register is acquired (S35).

Analysis unit (Pa3) may also determine whether a component in an instruction format is a comment or a register for the comment, in the same manner as it determines whether the component is a variable name or a register for the variable. When the component is determined to be a register for the comment, the comment stored in the register is acquired. When the component is a comment, the information for a register corresponding to the comment is acquired, and the comment stored in the register is obtained. Whether a component is a comment or not may be determined by the presence of a comment tag. Alternatively, analysis unit (Pa3) may also determine it is a comment when it is collated with database (DB) and does not match any data in the database.

Pieces of information about the command, variable name, register for the variable, and value of the variable as the analysis results are forwarded by analysis unit (Pa3) to display unit (Pa1). In watch window 13, display unit (Pa1) displays the received information about the command, variable name, register for the variable, value of the variable and comment (S36). At that time, display unit (Pa1) displays variable name information or variable register information in variable column (13a), variable value information in variable value column (13b), and comment information in comment column (13c).

In an embodiment of the present invention, a computer as a development support device is connected to a programmable controller. However, a computer may also be connected to a machine controller instead of a programmable controller. So far, preferred embodiments of the present invention have been described, but it should be understood that the present invention is not limited to those embodiments, and various modifications and changes are possible within the scope of the gist of the present invention.

In recent years, various devices such as general industrial machines and industrial robotics have come to require a high degree of functionality. Programmable logic controllers (hereinafter referred to as “PLCs”) excellent in controlling input/output (I/O) operations are generally used for controlling these various devices. Meanwhile, machine controllers (hereinafter also referred to as “motion controllers”) that use servos and inverters have also gained popularity for high-speed, high-accuracy controls capable of controlling complex operations of various devices.

When ladder logic is used as a control program (referred to as a ladder program: a control program using ladder logic) or when motion language is used as a control program (referred to as a motion program: a control program using motion language), the variables of monitoring targets are registered on a watch list to monitor the variables. When variables are registered on a watch list, values (values of variables) in the registers that store those variables are displayed on the screen so that the variable values (current values) are monitored.

Conventionally, to register target variables, names of individual variables to be monitored are inputted manually on a watch list. Also, registration on the watch list is conducted, for example, by selecting an element (switch, timer, lamp, etc.) corresponding to a variable in a ladder program and by dragging/dropping it; or by selecting the text corresponding to a variable in a motion program and by dragging/dropping it. Such selection is made, for example, by using a mouse to specify the range.

As described above, registering variables as monitoring targets on a watch list took time and is inconvenient. For example, if an input error occurs when a variable name is manually registered on a watch list, the current variable value of the monitoring target is not correctly displayed. In addition, variables are manually registered one by one, or unwanted variables are manually removed by the user.

A ladder program may have an expression function capable of expressing commands and variable calculations in a text format. Similar to C programming language, an expression function generally indicates a command (instruction) capable of, for example, describing multiple commands all at once (as one command (instruction)) in a text format. When such an expression function is used, an expression window is displayed on the inner side of power lines or on a rung structured in ladder logic, and commands or variable calculations are displayed in a text format in the expression window.

To register a variable in an expression window on a watch list, the variable described in the expression window is visually confirmed and the variable name to be monitored is manually input into the watch list. If an input error occurs during the manual input process, correct values of the variable are not displayed, and the current values cannot be monitored.

To register variables on a watch list in a motion program, the text corresponding to a variable is manually input or the range is specified. Thus, the same as above, if an input error occurs during the manual input process, correct values of the variable are not displayed to enable the monitoring of current values. When the range of the text corresponding to a variable is specified, occasionally, unnecessary portions are included or part of the necessary range is omitted. Accordingly, the same as above, correct values of the variable are not displayed to enable the monitoring of current values.

A development support device and a development support program according to embodiments of the present invention are capable of monitoring variables (current values) by simplified operations without forcing users to conduct complex procedures.

A development support device according to one aspect of the present invention has a display screen and is connected to a controller for controlling a target so as to help develop a control program that is written in a predetermined programming language and is stored in the controller. The development support device is provided with a database constructed with control command information to execute operational control or computational processing of a control target, variable name information to be used in operational control or computational processing, and register information for a variable to store current values of the variable corresponding to a variable name, and those pieces of information are associated with each other in the database. Also, the development support device includes a selection unit which acquires at least one type of information from among control command information, variable name information and variable register information according to the selection process by a user; an analysis unit which analyzes the selected information piece by piece based on the information in the database and acquires the current value of the variable according to the variable name information or the register information; and a display unit which displays the selected information analyzed by the analysis unit separately by the type of information, and which displays the current value of the variable acquired by the analysis unit.

When the information selected by a user does not remain to be selected for at least a predetermined duration, the selection unit does not have to acquire the information as selected information.

The predetermined programming language may be either ladder logic or programming language.

For each piece of control command information, the development support device may further contain an instruction format which is a list to specify the data array in relation to the control command. Separately by the type of information based on the instruction format, the analysis unit may analyze the selected information acquired by the selection unit.

When the information selected by the selection unit includes control command information, the analysis unit determines whether or not the control command information is text information. When the selected information is text information, the descriptions of the selected information in the control program may be analyzed line by line.

The development support device may further include a status determination unit capable of determining whether the control program has been compiled.

The status determination unit may further determine whether the control program is executed.

A development support program according to another aspect of the present invention directs a computer connected to a controller for controlling a target to function as follows. Namely, in the computer, a selection unit acquires at least one type of information selected by a selection process conducted by a user from among control command information, variable name information and register information for the variable, which are pieces of information written in a predetermined programming language and are stored in the controller. An analysis unit analyzes piece by piece the selected information acquired by the selection unit based on the information in a database which is constructed with control command information to execute operational control or computational processing of a control target, variable name information to be used in operational control or computational processing, and register information for a variable to store current values of the variable corresponding to the variable name, and those pieces of information are associated with each other in the database. The analysis unit also acquires the current value of the variable based on the variable name information or the variable register information. Moreover, a display unit displays the selected information analyzed by the analysis unit separately by the type of information, and also displays the current value of the variable acquired by the analysis unit.

According to an embodiment of the present invention, variables are monitored by simplified operations without forcing users to conduct complex procedures.

Obviously, numerous modifications and variations of the present invention are possible in light of the above teachings. It is therefore to be understood that within the scope of the appended claims, the invention may be practiced otherwise than as specifically described herein.

What is claimed is:

1. A development support device for supporting development of a control program written in a programming language and stored in a controller for controlling a target, comprising:
circuitry configured to
access a database including control command information which executes operational control or computational processing of the target, variable name information which is used in the operational control or the computational processing, and variable register information which stores a current value of a variable corresponding to a variable name such that the control command, variable name and variable register information are associated with each other in the database,
acquire at least one selected information selected from the control command information, the variable name information and the variable register information according to a selection process conducted by a user,
analyze each of the at least one selected information based on a type of the information in the database such that the current value of the variable is acquired according to the variable name information or the register information,
display the at least one selected information analyzed separately by the type of information, and
display the current value of the variable acquired by analysis of each of the at least one selected information,
wherein the target is controlled by the controller in which the control program written in the programming language is stored.

2. The development support device according to claim 1, wherein the circuitry is configured not to acquire information as the at least one selected information when the user selects a same information which is not to be selected continuously for a set period of time or longer.

3. The development support device according to claim 1, wherein the programming language is at least one of ladder logic language and motion language.

4. The development support device according to claim 1, wherein the circuitry is configured to
access an instruction format including a list which specifies data array related to control command for each of the control command information, and
analyze the at least one selected information separately by the type of information based on the instruction format.

5. The development support device according to claim 4, wherein the circuitry is configured to
determine whether or not the control command information is text information when the at least one selected information includes the control command information, and
analyze the at least one selected information for each line of descriptions in the control program when the at least one selected information is the text information.

6. The development support device according to claim 1, wherein the circuitry is configured to determine whether a compile process on the control program is completed.

7. The development support device according to claim 6, wherein the circuitry is configured to determine whether the control program is executed.

8. The development support device according to claim 2, wherein the programming language is at least one of ladder logic language and motion language.

9. The development support device according to claim 2, wherein the circuitry is configured to
access an instruction format including a list which specifies data array related to control command for each of the control command information, and
analyze the at least one selected information separately by the type of information based on the instruction format.

10. The development support device according to claim 9, wherein the circuitry is configured to
determine whether or not the control command information is text information when the at least one selected information includes the control command information, and
analyze the at least one selected information for each line of descriptions in the control program when the at least one selected information is the text information.

11. The development support device according to claim 2, wherein the circuitry is configured to determine whether a compile process on the control program is completed.

12. The development support device according to claim 11, wherein the circuitry is configured to determine whether the control program is executed.

13. The development support device according to claim 3, wherein the circuitry is configured to
access an instruction format including a list which specifies data array related to control command for each of the control command information, and
analyze the at least one selected information separately by the type of information based on the instruction format.

14. The development support device according to claim 13, wherein the circuitry is configured to
determines whether or not the control command information is text information when the at least one selected information includes the control command information, and
analyze the at least one selected information for each line of descriptions in the control program when the at least one selected information is the text information.

15. The development support device according to claim 3, wherein the circuitry is configured to determine whether a compile process on the control program is completed.

16. The development support device according to claim 15, wherein the circuitry is configured to determine whether the control program is executed.

17. The development support device according to claim 4, wherein the circuitry is configured to determine whether a compile process on the control program is completed.

18. The development support device according to claim 17, wherein the circuitry is configured to determine whether the control program is executed.

19. The development support device according to claim 5, wherein the circuitry is configured to determine whether a compile process on the control program is completed.

20. A non-transitory computer readable medium having stored thereon a program that when executed by a computer causes the computer having circuitry to execute a development support method for supporting development of a control program written in a programming language and stored in a controller for controlling a target, the development support method comprising:
accessing a database including control command information which executes operational control or computational processing of the target, variable name information which is used in the operational control or the computational processing, and variable register information which stores a current value of a variable corresponding to a variable name such that the control command, variable name and variable register information are associated with each other in the database;
acquiring at least one selected information selected from the control command information, the variable name information and the variable register information according to a selection process conducted by a user;
analyzing each of the at least one selected information based on a type of the information in the database such that the current value of the variable is acquired according to the variable name information or the register information;
displaying the at least one selected information analyzed separately by the type of information; and
displaying the current value of the variable acquired by analysis of each of the at least one selected information,
wherein the target is controlled by the controller in which the control program written in the programming language is stored.
